(19) United States
(12) Patent Application Publication
(10) Pub. No.: US 2019/0362373 A1
(43) Pub. Date: Nov. 28, 2019

(54) METHOD FOR BEHAVIOR REWARDING, SERVER AND COMPUTER DEVICE

(71) Applicant: KAIWAY TECH CO., LTD., Taipei City (TW)

(72) Inventors: Yi-Chung LIN, Taipei City (TW); Chih-Feng HUANG, Taipei City (TW); Yung-Hsiang CHANG, Taipei City (TW)

(21) Appl. No.: 16/233,632

(22) Filed: Dec. 27, 2018

(30) Foreign Application Priority Data
May 25, 2018 (TW) 107118054

(51) Int. Cl. G06Q 30/02; G06Q 50/00

(52) U.S. Cl. CPC G06Q 30/0217; G06Q 50/01; G06Q 30/0239; G06Q 30/0224

(57) ABSTRACT

A method for behavior rewarding is applied in a rewarding system, which comprises a computer device and a server. The computer device is configured for a user to execute a designated action and communicates with the server. The method comprises the following steps: receiving an execution request of a plurality of designated actions by the computer device, wherein the designated actions at least comprises a special action or a random action; transmitting an execution result of the designated actions from the computer device to the server; and, when determining that the execution result of the designated actions matches the execution request of the designated actions, transmitting a rewarding value corresponding to the designated actions from the server to the computer device. A server and a computer device for executing the method for behavior rewarding are also disclosed.

### CROSS REFERENCE TO RELATED APPLICATIONS

This Non-provisional application claims priority under 35 U.S.C. § 119(a) on Patent Application No(s). 107118054 filed in Taiwan, Republic of China on May 25, 2018, the entire contents of which are hereby incorporated by reference.

### BACKGROUND

### Technology Field

The present disclosure relates to a rewarding method and, in particular, to a method for providing a rewarding value to a user who finishes a plurality of actions. In addition, the present disclosure also relates to a server and a user computer device.

### Description of Related Art

On the social network platforms and/or communication software (including but not limited to Facebook, Instagram, Twitter, Tumblr, and/or Weibo, etc.), users or consumers usually give a thumbs-up sign, a score (e.g. one to five stars), a written comment for interacting and communicating with the service providers or merchants. The users or consumers may get some rewards when giving “likes” or score, or the users or consumers may just give the comment without rewards. The above-mentioned rewards provided by the system or merchants are usually for increasing the usage frequency or attractive to the users and/or the consumers to the system or the merchant. In detailed, the system or merchant may selectively give a corresponding response to the user or consumer who expresses the opinion. The provided rewards are designed to encourage users or consumers to express their opinions, and also to increase the visibility of the system or merchant.

However, the corresponding mechanism provided by the aforementioned social network platform and/or communication software only provides bonus and reward to users for a single behavior. The advantage of this approach is that it can quickly collect a large number of user opinions, while widely exposing the merchant or system to the consumers. However, the aforementioned method is often abused by users or merchants. The problem is that consumers or users can obtain rewards from merchants by simply reflective operations without thinking or effort. In order to get rapid exposure rate, the system platform is often laissez-faire for such reflective unreliable operations. Over time, the authenticity and advertising value of this scoring or commenting mechanism will be diluted by the aforementioned large number of reflective operations. Even if a merchant can often get a lot of high scores or “likes”, the actual advertising effect is still doubtful.

Besides, there is another problem caused by the single evaluation behavior. That is, the single evaluation behavior cannot create the interactive schema between the users or consumers and the service providers or merchants.

Therefore, it is desired to provide a bonus rewarding method that can achieve the rapid exposure and the interactive schema between the user/consumer and the service provider/merchant, thereby obtaining the substantial advertising effect and advertising value.

### SUMMARY

In view of the foregoing, an objective of the disclosure is to provide a method for behavior rewarding, and a server and a computer device for executing the method for behavior rewarding. This disclosure provides a plurality of designated actions for the user to do, thereby creating a special schema information constructed by the designated actions. That is, it is unnecessary to always do the same action at the same place. In addition, the users or consumers need to pay some attentions and efforts for getting the real bonus and rewards. Accordingly, the above method can make the executed actions (e.g. the consumer gives scores to the merchant) have “authenticity”. Moreover, the user/consumer can get high “identity” through executing the designated actions, and the substantial advertising effect can be achieved and rapidly spread.

To achieve the above objective, a method for behavior rewarding of the present disclosure is applied in a rewarding system comprising a computer device and a server. The computer device is configured for a user to execute a designated action and communicates with the server. The method comprising following steps of: receiving an execution request of a plurality of designated actions by the computer device, wherein the designated actions at least comprises a special action or a random action; transmitting an execution result of the designated actions from the computer device to the server; and when determining that the execution result of the designated actions matches the execution request of the designated actions, transmitting a rewarding value corresponding to the designated actions from the server to the computer device.

In one embodiment, when the server determines that an execution order of the designated actions and an execution content of each of the designated actions are true, the server transmits the rewarding value to the computer device.

In one embodiment, an order of the designated actions is a random order.

In one embodiment, the special action or the random action is designated by the server or an operator.

In one embodiment, the designated actions form a schema type information.

In one embodiment, the rewarding value is a cryptocurrency, a real currency, a system point, or a coupon.

In addition, the present disclosure also provides a server applied in a rewarding system. The rewarding system comprises a computer device and the server. The server communicates with the computer device, and the computer device is configured for a user to execute a designated action. The server comprises one or more processing units, and a storage unit storing a plurality of instructions and coupling with the one or more processing units. The one or more processing units execute the instructions to allow the server to execute following processes: transmitting an execution request of a plurality of designated actions to the computer device, wherein the designated actions at least comprises a special action or a random action; receiving an execution result of the designated actions outputted from the computer device; and determining whether the execution result of the designated actions matches the execution request of the designated actions or not, wherein when determining that the execution result of the designated actions matches the execution request of the designated actions, the server transmits a rewarding value corresponding to the designated actions to the computer device.

In one embodiment, when the server determines that an execution order of the designated actions and an execution content of each of the designated actions are true, the server transmits the rewarding value to the computer device.

In one embodiment, an order of the designated actions is randomly arranged by the server.

In one embodiment, the special action or the random action is designated by the server or an operator.

In one embodiment, the designated actions form a schema type information.

In one embodiment, the rewarding value is a cryptocurrency, a real currency, a system point, or a coupon.

Furthermore, this disclosure also provides a computer device applied in a rewarding system. The rewarding system comprises a server and the computer device. The computer device communicates with the server, and the computer device is configured for a user to execute a designated action. The computer device comprises a memory unit storing a plurality of instructions and one or more processing units coupling with the memory unit. The one or more processing units execute the instructions to perform following processes: receiving an execution request of a plurality of designated actions, wherein the designated actions at least comprises a special action or a random action; transmitting an execution result of the designated actions to the server; and when determining that the execution result of the designated actions matches the execution request of the designated actions, receiving a rewarding value corresponding to the designated actions outputted from the server.

In one embodiment, when the server determines that an execution order of the designated actions and an execution content of each of the designated actions are true, the computer device receives the rewarding value outputted from the server.

In one embodiment, an order of the designated actions is randomly arranged by the server.

In one embodiment, the special action or the random action is designated by the server or an operator.

In one embodiment, the designated actions form a schema type information.

In one embodiment, the rewarding value is a cryptocurrency, a real currency, a system point, or a coupon.

As mentioned above, this disclosure provides a plurality of designated actions for the user to do, thereby creating a special schema information constructed by the designated actions. That is, it is unnecessary to always do the same action at the same place. Meanwhile, the users or consumers need to pay some attentions and efforts for getting the real bonus and rewards. Accordingly, the above method can make the executed actions (e.g. the consumer gives scores to the merchant) have “authenticity”. Moreover, the user/consumer can get high “identity” through executing the designated actions, and the substantial advertising effect can be achieved and rapidly spread.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a flow chart showing a method for behavior rewarding according to an embodiment of this disclosure;

FIG. 2 is a schematic diagram showing a rewarding system according to another embodiment of this disclosure; and

FIG. 3 is a schematic diagram showing a server, a user computer device, and a store computer device of FIG. 2.

### DETAILED DESCRIPTION OF THE DISCLOSURE

The present disclosure will be apparent from the following detailed description, which proceeds with reference to the accompanying drawings, wherein the same references relate to the same elements.

It is to be noted that all directional indications (such as up, down, left, right, front, rear and the like) in the embodiments of the present disclosure are only used for explaining the relative positional relationship, circumstances during its operation, and the like, between the various components in a certain specific posture (as shown in the accompanying drawings). If the specific posture changes, the directional indication will also change accordingly.

Several embodiments of the disclosure are provided below. Although each embodiment represents a possible combination of the disclosed elements, this disclosure should still include all possible combinations of the disclosed elements. Thus, if an embodiment includes elements A, B, and C, and another embodiment includes elements B and D, this disclosure should be understood to include any combinations of A, B, C, and/or D, even if not explicitly disclosed.

The alternative elements or groups of embodiments disclosed herein are not to be construed as limiting the disclosure. Each group member may be referred to and claimed individually or in any manner that is arbitrarily combined with other members of the group or other elements herein. One or more members of the group may be included in or deleted from the group for reasons of convenience and/or patentability. Any term in the specification, even if it is not found in the scope of the claims, should not be construed as an essential element of the disclosure.

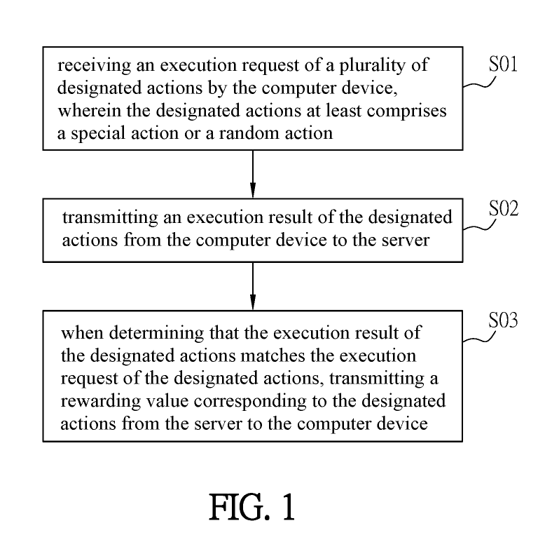

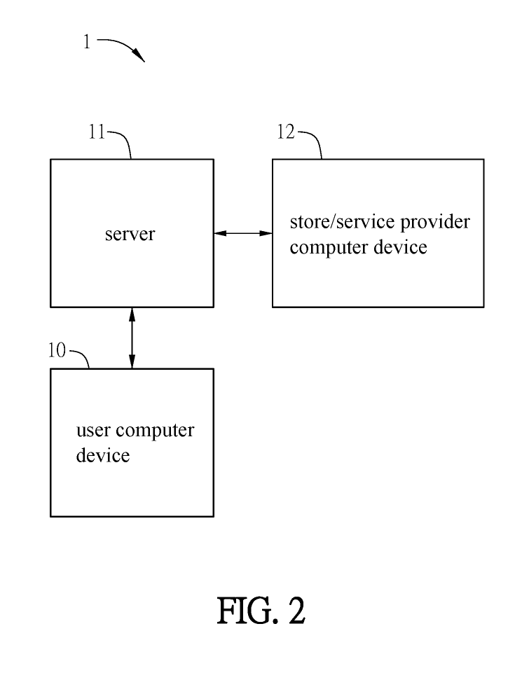

FIG. 1 is a flow chart showing a method for behavior rewarding according to an embodiment of this disclosure, and FIG. 2 is a schematic diagram showing a rewarding system according to another embodiment of this disclosure. Referring to FIGS. 1 and 2, the method for behavior rewarding of this embodiment is applied in a rewarding system 1 comprising a computer device 10 and a server 11. In the following embodiment, the computer device 10 is configured for a user to execute a designated action, so it can also be realized as a user computer device 10. The server 11 communicates with the user computer device 10. In addition, another computer device disposed in a store can be realized as a store/service-provider computer device 12, which also communicates with the server 11. The above-mentioned communication can be, for example but not limited to, through network connection.

The method for behavior rewarding of this embodiment comprises following steps: a step S01: receiving an execution request of a plurality of designated actions by the computer device 10, wherein the designated actions at least comprises a special action or a random action; a step S02: transmitting an execution result of the designated actions from the computer device 10 to the server 11; and a step S03: when determining that the execution result of the designated actions matches the execution request of the designated actions, transmitting a rewarding value corresponding to the designated actions from the server 11 to the computer device 10.

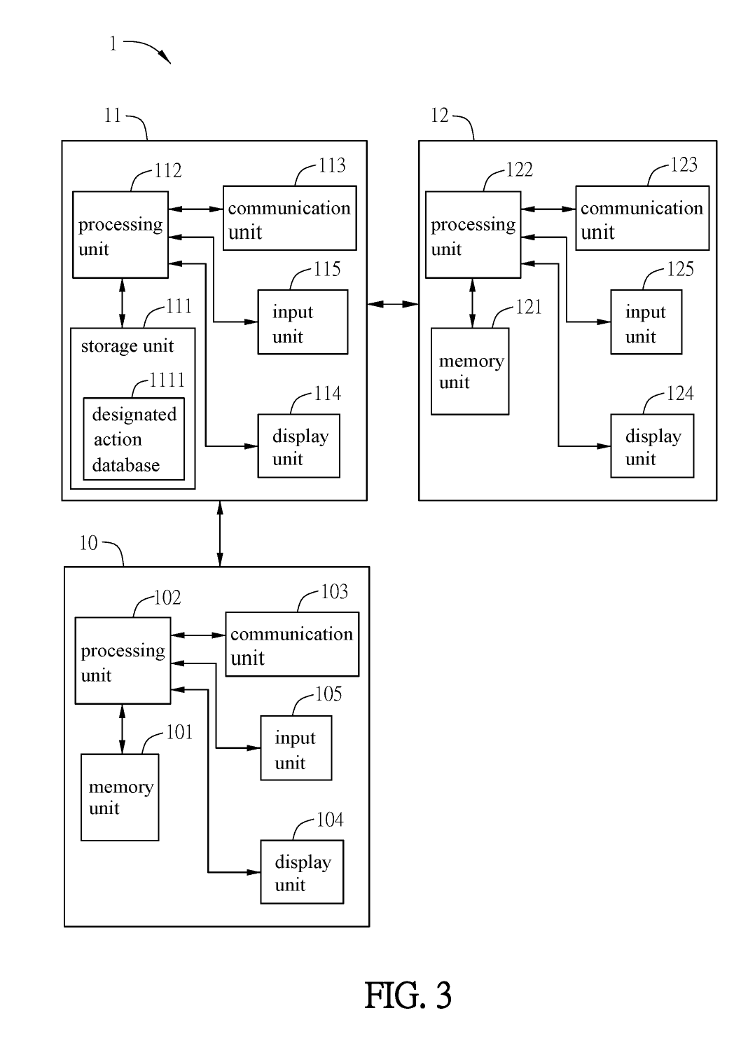

To be noted, the designated action can be generated by the server 11 or be designated by others (e.g. a store). The designated actions, which are generated by the server 11 and designated to the user computer device 10, can be all automatically selected by the server 11. For example, the server 11 can randomly select the designated actions from a designated action database 1111 as shown in FIG. 3 (referred to the above-mentioned random actions). Alternatively, the server 11 may randomly select one or some of the designated actions from the designated action database 1111 as shown in FIG. 3, and the residual designated actions can be selected from the designated action database 1111 as shown in FIG. 3 according to a preset. In addition, the above-mentioned random actions can be one or more designated actions randomly selected from a plurality of candidate actions, or a plurality of designated actions in a random order.

As mentioned above, the designated actions can be the above-mentioned special actions and designated by an operator. In more detailed, a store or a service provider may link the store/service provider computer device 12 to the server 11, select the designated actions from the designated action database 1111 (see FIG. 3), and then transmit the selected designated actions from the server 11 to the user computer device 10. Alternatively, the store may directly input the required actions, and then the server 11 can transmit the related designated actions from the server 11 to the user computer device 10. Moreover, the designated actions may comprise one or more random actions, one or more special actions, and one or more preset designated actions, which are selected from the designated action database 1111 (see FIG. 3) according to a preset of the server 11.

In this embodiment, the step of the server 11 determining that whether the execution result of the designated actions matches the execution request of the designated actions or not is further to determine that whether an execution order of the designated actions and execution contents of the designated actions are true. When the server 11 determines that an execution order of the designated actions and execution contents of the designated actions are true, the server 11 determines that the execution result of the designated actions matches the execution request of the designated actions. In addition, the server 1 may randomly arrange the execution order of the designated actions, and then transmit the execution request of the designated actions to the user computer device 10.

For example, in this embodiment, the service 11 generates five designated actions including the actions 1 to 5. The action 1 is to request the user to consume at the store. The action 2 is to require the user to indicate that he/she has been consumed at the store by checking and sharing in the App of the rewarding system, or on the social networking platform such as Facebook, Instagram, Twitter, Tumblr, and/or Weibo. The action 3 is to require the user to upload the photo of the goods or service (such as food, movie tickets, etc.) purchased by the user to the app of the feedback system or the social networking platform such as Facebook, Instagram, Twitter, Tumblr, and/or Weibo. The action 4 is to require the user to rate the consumer service provided by the store. The action 5 is to require the user to purchase a specific goods in this purchasing. In this case, the action 1 is randomly assigned by the server 11 from the current rewarding process, and the action 1 is randomly selected by the server 11 from the designated action database 1111 (see FIG. 3). The action 5 is a special designated action made by the store in this rewarding process.

In one aspect, when the user finishes the above-mentioned actions 1 to 5 (the actions 1-5 are not to be finished in order), the execution result of the designated actions can be transmitted from the user computer device 10 to the server 11 for the following checking process. Then, the server 11 may only determine that whether the designated actions (the actions 1-5) sent to the user computer device 10 have been executed or not, and the server 11 is unnecessary to determine the execution order of the actions. In other words, when the server 11 determines that the execution result of the designated actions, which is transmitted form the user computer device 10 to the server 11, matches the requested execution contents, the server 11 can determine that the execution result of the designated actions matches the execution request of the designated actions, and then transmit a rewarding value corresponding to the designated actions to the user computer device 10.

In another aspect, the order of the designated actions can be arranged in a random order by the server 11. For example, the five designation actions are arranged as the action 1, the action 3, the action 5, the action 4 and the action 2. These five actions can form a special schema information (described below). After the user computer device 10 transmits the execution result of the designated actions to the server 11 for comparing, the server 11 will determine that whether the execution contents and execution order of the designated actions (actions 1-5) are finished based on the execution request and the requested order of the designated actions. In other words, only when the execution result of the designated actions, which is transmitted from the user computer device 10 to the server 11, must match the requested execution contents, and the finished order of these designated actions must match the requested order of “action 1, action 3, action 5, action 2 and action 4”, the server 11 can determine that the execution result of the designated actions matches the execution request of the designated actions. Then, the server 11 will transmit a rewarding value corresponding to the designated actions to the user computer device 10.

In this embodiment, the above-mentioned designated actions can construct a schema type information. Herein, the server 11 can generate a plurality of designated actions for the user to execute by the above-mentioned procedure, thereby constructing a special schema information. For example, when the consumer is in a schema of going to a restaurant, the server 11 may issue four designated actions for the user. Then, the user can get the above-mentioned rewarding value after finishing the four designated actions. In this case, the action 1 is to check in the restaurant, the action 2 is to order a promoted special set of the restaurant, the action 3 is to write a comment for the foods, and the action 4 is to take a photo with the waiter in front of the restaurant and to upload the photo to Facebook. In the above example, the action 2 is a “special action” designated by the restaurant, and the action 4 is randomly designated by the rewarding system 1. Accordingly, the actions 1 to 4 can construct a schema type information of “dinning in a restaurant”.

In this embodiment, the server 11 can provide a corresponding designated action based on different application scene of the user, so that the user can incorporate into the application scene when executing the designated actions. As mentioned above, since the designated actions may comprise at least one random action or special action, the user may execute different actions in the same place. This design makes the user or consumer to pay some attentions and efforts for getting the real bonus and rewards. Accordingly, the above method can make the executed actions (e.g. the consumer gives scores to the merchant) have “authenticity”. Moreover, the user/consumer can get high “identity” through executing the designated actions, and the substantial advertising effect can be achieved and rapidly spread.

The above-mentioned schema type information can also be “a sport schema” (e.g. the consumer works out in a gym), “an estate schema” (e.g. to buying a house), “a transportation schema” (e.g. buying an MRT ticket and taking the MRT), “an education schema” (e.g. going to a tutoring class), or “a show schema” (e.g. buying a concert ticket and going to the concert). In other words, the schema type information is different in different application scenes, so that different rewards should be defined for different schema type information. To be noted, the actions can be, for example but not limited to, ratings, reviews, photo uploading, dining, listening to lessons, walking, signing a lease contract, running, watching a movie, etc.

In this embodiment, the rewarding value can be a cryptocurrency, a real currency, a system point, a coupon, or any combination thereof.

FIG. 3 is a schematic diagram showing a server and a user computer device according to one embodiment of this disclosure. The server 11 of this embodiment is applied to the above-mentioned rewarding system 1. As shown in the figure, the server 11 comprises a storage unit 111, one or more processing units 112, a communication unit 113, a display unit 114, an input unit 115, and a housing (not shown). The storage unit 111, the processing units 112 and the communication unit 113 are disposed inside the housing of the server 11. In this embodiment, only one processing unit 112 is shown in FIG. 3 for making the drawing more simple and clean.

The processing unit 112 is coupled to the storage unit 111, the communication unit 113, the display unit 114, and the input unit 115, and is configured to execute an instruction (e.g. a program code) to perform the above-mentioned method for behavior rewarding. The processing unit 112 is, for example, a processor capable of executing instructions (e.g., program codes), and each processor may also include one or more cores. The storage unit 111 (also referred to as a memory unit) may be a random memory or a non-volatile computer readable storage medium. The non-volatile computer readable storage medium is, for example, a hard disk, a solid state drive (SSD), a flash memory or the likes that stores instructions (e.g. program codes) executable by the processing unit 112. The processing unit 112 can load instructions (e.g. program codes) from a non-volatile computer readable storage medium to the random memory and execute the loaded instructions. The communication unit 113 is, for example, a network card, a network chip, a modem, or the likes that can provide network connection. The display unit 114 includes a display card, a display chip, a display, and the likes. The input unit 115 is, for example, a keyboard, a mouse, or a touch screen.

For example, the one or more processing units 112 of the server 11 execute the instructions stored in the storage unit 111 to allow the server 11 to execute following processes: transmitting an execution request of a plurality of designated actions to the user computer device 10, wherein the designated actions at least comprises a special action or a random action; receiving an execution result of the designated actions outputted from the user computer device 10; and determining whether the execution result of the designated actions matches the execution request of the designated actions or not, wherein when determining that the execution result of the designated actions matches the execution request of the designated actions, the server 11 transmits a rewarding value corresponding to the designated actions to the user computer device 10.

In this embodiment, as mentioned above, the designated actions can be selected from the designated action database 1111 of the server 11. As shown in FIG. 3, the designated action database 1111 can be stored in the storage unit 111, and the processing unit 112 or other related unit may access the storage unit 111 if necessary.

In this embodiment, the rewarding value can be a cryptocurrency, a real currency, a system point, a coupon, or any combination thereof.

In this embodiment, the configuration of the detailed components of the server 11, the connection of the components, the selection of the designated actions, the designated and/or arranged order, and the modification of the determining conditions of the designated actions can be referred to the above embodiment, and the detailed description thereof will be omitted.

In another embodiment, this disclosure provides a user computer device 10, which is applied to the above-mentioned rewarding system 1. Similarly, referring to FIG. 3, the user computer device 10 comprises a memory unit 101, one or more processing units 102, a communication unit 103, a display unit 104, an input unit 105, and a housing (not shown). The memory unit 101, the processing units 102 and the communication unit 103 are disposed inside the housing of the user computer device 10. In this embodiment, only one processing unit 102 is shown in FIG. 3 for making the drawing more simple and clean.

The processing unit 102 is coupled to the memory unit 101, the communication unit 103, the display unit 104, and the input unit 105, and is configured to execute an instruction (e.g. a program code) to perform the above-mentioned method for behavior rewarding. The processing unit 102 is, for example, a processor capable of executing instructions (e.g., program codes), and each processor may also include one or more cores. The memory unit 101 may be a random memory or a non-volatile computer readable storage medium. The non-volatile computer readable storage medium is, for example, a hard disk, a solid state drive (SSD), a flash memory or the likes that stores instructions (e.g. program codes) executable by the processing unit 102. The processing unit 102 can load instructions (e.g. program codes) from a non-volatile computer readable storage medium to the random memory and execute the loaded instructions. The communication unit 103 is, for example, a network card, a network chip, a modem, or the likes that can provide network connection. The display unit 104 includes a display card, a display chip, a display, and the likes. The input unit 105 is, for example, a keyboard, a mouse, or a touch screen.

For example, the one or more processing units 102 of the user computer device 10 execute the instructions stored in the memory unit 101 to allow the user computer device 10 to execute following processes: receiving an execution request of a plurality of designated actions transmitted from the server 11, wherein the designated actions at least comprises a special action or a random action; transmitting an execution result of the designated actions to the server 11; and when the server 11 determines that the execution result of the designated actions matches the execution request of the designated actions, receiving a rewarding value corresponding to the designated actions outputted from the server 11.

In this embodiment, as mentioned above, the designated actions issued by the server 11 at least comprise a special action or a random action. The above-mentioned designated actions can be selected from the designated action database 1111 of the server 11.

In this embodiment, the rewarding value can be a cryptocurrency, a real currency, a system point, a coupon, or any combination thereof.

As shown in FIG. 3, a store/service provider computer device 12 comprises a memory unit 121, one or more processing units 122, a communication unit 123, a display unit 124, an input unit 125, and a housing (not shown). The memory unit 121, the processing units 122 and the communication unit 123 are disposed inside the housing of the store/service provider computer device 12. In this embodiment, only one processing unit 102 is shown in FIG. 3 for making the drawing more simple and clean. The processing unit 122 is coupled to the memory unit 121, the communication unit 123, the display unit 124, and the input unit 125, and is configured to execute an instruction (e.g. a program code) to perform the above-mentioned method for behavior rewarding. The processing unit 122 is, for example, a processor capable of executing instructions (e.g., program codes), and each processor may also include one or more cores. The memory unit 121 may be a random memory or a non-volatile computer readable storage medium. The non-volatile computer readable storage medium is, for example, a hard disk, a solid state drive (SSD), a flash memory or the likes that stores instructions (e.g. program codes) executable by the processing unit 122. The processing unit 122 can load instructions (e.g. program codes) from a non-volatile computer readable storage medium to the random memory and execute the loaded instructions. The communication unit 123 is, for example, a network card, a network chip, a modem, or the likes that can provide network connection. The display unit 124 includes a display card, a display chip, a display, and the likes. The input unit 125 is, for example, a keyboard, a mouse, or a touch screen. In practice, the one or more processing units 122 of the store/service provider computer device 12 can execute the instructions stored in the memory unit 121 for performing the actions of, for example, selecting the designated actions and additional designated actions by the store.

In this embodiment, the configuration of the detailed components of the user computer device 10, the connection of the components, the selection of the designated actions, the designated and/or arranged order, and the modification of the determining conditions of the designated actions can be referred to the above embodiment, and the detailed description thereof will be omitted.

In summary, this disclosure provides a plurality of designated actions for the user to do, thereby creating a special schema information constructed by the designated actions. That is, it is unnecessary to always do the same action at the same place. Meanwhile, the users or consumers need to pay some attentions and efforts for getting the real bonus and rewards. Accordingly, the above method can make the executed actions (e.g. the consumer gives scores to the merchant) have “authenticity”. Moreover, the user/consumer can get high “identity” through executing the designated actions, and the substantial advertising effect can be achieved and rapidly spread.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A method for behavior rewarding, which is applied in a rewarding system comprising a computer device and a server, wherein the computer device is configured for a user to execute a designated action and communicates with the server, the method comprising following steps of:
receiving an execution request of a plurality of designated actions by the computer device, wherein the designated actions at least comprises a special action or a random action;
transmitting an execution result of the designated actions from the computer device to the server; and
when determining that the execution result of the designated actions matches the execution request of the designated actions, transmitting a rewarding value corresponding to the designated actions from the server to the computer device.

2. The method according to claim 1, wherein when the server determines that an execution order of the designated actions and an execution content of each of the designated actions are true, the server transmits the rewarding value to the computer device.

3. The method according to claim 1, wherein an order of the designated actions is a random order.

4. The method according to claim 1, wherein the special action or the random action is designated by the server or an operator.

5. The method according to claim 1, wherein the designated actions form a schema type information.

6. The method according to claim 1, wherein the rewarding value is a cryptocurrency, a real currency, a system point, or a coupon.

7. A server applied in a rewarding system, wherein the rewarding system comprises a computer device and the server, the server communicates with the computer device, and the computer device is configured for a user to execute a designated action, the server comprising:
one or more processing units; and
a storage unit storing a plurality of instructions and coupling with the one or more processing units;
wherein, the one or more processing units execute the instructions to allow the server to execute following processes:
transmitting an execution request of a plurality of designated actions to the computer device, wherein the designated actions at least comprises a special action or a random action;
receiving an execution result of the designated actions outputted from the computer device; and
determining whether the execution result of the designated actions matches the execution request of the designated actions or not, wherein when determining that the execution result of the designated actions matches the execution request of the designated actions, the server transmits a rewarding value corresponding to the designated actions to the computer device.

8. The server according to claim 7, wherein when the server determines that an execution order of the designated actions and an execution content of each of the designated actions are true, the server transmits the rewarding value to the computer device.

9. The server according to claim 7, wherein an order of the designated actions is randomly arranged by the server.

10. The server according to claim 7, wherein the special action or the random action is designated by the server or an operator.

11. The server according to claim 7, wherein the designated actions form a schema type information.

12. The server according to claim 7, wherein the rewarding value is a cryptocurrency, a real currency, a system point, or a coupon.

13. A computer device applied in a rewarding system, wherein the rewarding system comprises a server and the computer device, the computer device communicates with the server, and the computer device is configured for a user to execute a designated action, the computer device comprising:
a memory unit storing a plurality of instructions; and
one or more processing units coupling with the memory unit, wherein the one or more processing units execute the instructions to perform following processes:
receiving an execution request of a plurality of designated actions, wherein the designated actions at least comprises a special action or a random action;
transmitting an execution result of the designated actions to the server; and
when determining that the execution result of the designated actions matches the execution request of the designated actions, receiving a rewarding value corresponding to the designated actions outputted from the server.

14. The computer device according to claim 13, wherein when the server determines that an execution order of the designated actions and an execution content of each of the designated actions are true, the computer device receives the rewarding value outputted from the server.

15. The computer device according to claim 13, wherein an order of the designated actions is randomly arranged by the server.

16. The computer device according to claim 13, wherein the special action or the random action is designated by the server or an operator.

17. The computer device according to claim 13, wherein the designated actions form a schema type information.

18. The computer device according to claim 13, wherein the rewarding value is a cryptocurrency, a real currency, a system point, or a coupon.
